(19) United States
(12) Patent Application Publication
(10) Pub. No.: US 2026/0116201 A1
(43) Pub. Date: Apr. 30, 2026

(54) POWER SUPPLY DEVICE FOR MOVING OBJECT

(71) Applicant: TOYOTA JIDOSHA KABUSHIKI KAISHA, Toyota-shi (JP)

(72) Inventors: Yoshihiko HIROE, Toyota-shi (JP); Miki MASUMOTO, Toyota-shi (JP)

(73) Assignee: TOYOTA JIDOSHA KABUSHIKI KAISHA, Toyota-shi (JP)

(21) Appl. No.: 19/341,376

(22) Filed: Sep. 26, 2025

(30) Foreign Application Priority Data
Oct. 25, 2024 (JP) 2024-188588

(51) Int. Cl. B60L 3/04; B60L 50/60; H02H 3/16

(52) U.S. Cl. CPC B60L 3/04; H02H 3/16; B60L 50/60

(57) ABSTRACT

In a power supply device, a storage battery and an electric load are connected via a positive-side wire and a negative-side wire, and the negative-side wire is grounded to a vehicle body via a ground wire. A Pyro-Fuse is disposed on the ground wire. When an interruption control unit detects that the positive-side wire has come into contact with the vehicle body, the interruption control unit activates the Pyro-Fuse. The ground wire is thus disconnected, thereby reducing the possibility of short-circuiting between the positive-side wire and the negative-side wire.

### CROSS-REFERENCE TO RELATED APPLICATION

This application claims priority to Japanese Patent Application No. 2024-188588 filed on Oct. 25, 2024. The disclosure of the above-identified application, including the specification, drawings, and claims, is incorporated by reference herein in its entirety.

### BACKGROUND

### 1. Technical Field

The present disclosure relates to power supply devices for moving objects.

### 2. Description of Related Art

Japanese Unexamined Patent Application Publication No. 2023-110653 (JP 2023-110653 A) discloses an in-vehicle power supply system in which a storage battery and a charger are connected via a voltage conversion module. The voltage conversion module of the in-vehicle power supply system is electrically isolated from the vehicle-side ground, and the ground line is connected to the charger-side ground. In the voltage conversion module, the ground line is connected to the vehicle-side ground via a current interruption unit, and the current interruption unit interrupts current flow in the ground line when a current greater than or equal to a rated current flows through the ground line.

On the other hand, Japanese Unexamined Patent Application Publication No. 2023-127974 (JP 2023-127974 A) discloses a vehicle power supply device that supplies power to a low-voltage load and to a high-voltage load driven at a voltage higher than that of the low-voltage load. The vehicle power supply device includes a first energy storage element group serving as a power source for the low-voltage load and a second energy storage element group connected in series with the first energy storage element group and serving as a power source for the high-voltage load.

In the vehicle power supply device, the first energy storage element group is connected to the low-voltage load via first switching means on the negative electrode side and second switching means on the positive electrode side, and the second energy storage element group is connected to the high-voltage load via a first cutoff switch on the negative electrode side and a second cutoff switch on the positive electrode side, both serving as cutoff means. The connection between the first switching means and the low-voltage load is grounded to the vehicle body.

In the vehicle power supply device, leakage detection means is provided between the cutoff means and the high-voltage load. When leakage is detected by the leakage detection means, control means turns off the first cutoff switch and the second cutoff switch.

### SUMMARY

A power supply device provided in a vehicle is surrounded by the vehicle body. Accordingly, if a positive-side wire comes into contact with the vehicle body, the storage battery may become short-circuited via the vehicle body and a ground wire that connects the vehicle body and a negative-side wire.

The present disclosure has been made in view of the above circumstances, and an object thereof is to provide a power supply device for a moving object that can reduce the possibility of a storage battery becoming short-circuited even when a positive-side wire comes into contact with the body of the moving object.

In order to achieve the above object, a power supply device for a moving object of a first aspect includes: a storage battery mounted on the moving object, connected to an electric load via a positive-side wire and a negative-side wire, and configured to supply electric power to the electric load; a ground wire that connects the negative-side wire at a single point to a body of the moving object in which the storage battery and the electric load are housed; and a cutoff unit configured to interrupt a connection between the negative-side wire and the body via the ground wire when determination is made that the positive-side wire has come into contact with the body.

In the power supply device of the first aspect, the storage battery is mounted on the moving object, is connected to the electric load via the positive-side wire and the negative-side wire, and is configured to supply electric power to the electric load. The negative-side wire is connected to the body of the moving object via the ground wire and is thus grounded.

The cutoff unit interrupts the connection between the negative-side wire and the body via the ground wire when the positive-side wire comes into contact with the body. As a result, the negative-side wire is electrically insulated from the body, thereby reducing the possibility of the storage battery being short-circuited even when the positive-side wire comes into contact with the body.

According to a power supply device for a moving object of a second aspect, in the first aspect, the cutoff unit includes an interrupter configured to interrupt the connection via the ground wire when activated, and an interruption control unit configured to control activation of the interrupter. The interruption control unit is configured to activate the interrupter when at least one of an output voltage and an output current of the storage battery falls out of a predetermined specified range.

In the power supply device of the second aspect, the cutoff unit includes the interrupter configured to interrupt the connection via the ground wire when activated, and the interruption control unit configured to control activation of the interrupter. The interruption control unit is configured to activate the interrupter when at least one of the output voltage and the output current of the storage battery falls out of the predetermined specified range. As a result, the negative-side wire is electrically insulated from the body, thereby efficiently reducing the possibility of the storage battery being short-circuited even when the positive-side wire comes into contact with the body.

According to a power supply device for a moving object of a third aspect, in the first aspect, the cutoff unit includes an interrupter configured to interrupt the connection via the ground wire when activated, and an interruption control unit configured to control activation of the interrupter. The interruption control unit is configured to activate the interrupter when a current value of the ground wire exceeds a predefined current value.

In the power supply device of the third aspect, the cutoff unit includes the interrupter configured to interrupt the connection via the ground wire when activated, and the interruption control unit configured to control activation of the interrupter. The interruption control unit is configured to activate the interrupter when the current value of the ground wire exceeds the predefined current value. As a result, the negative-side wire is electrically insulated from the body, thereby efficiently reducing the possibility of the storage battery being short-circuited even when the positive-side wire comes into contact with the body.

According to the present disclosure, the cutoff unit is provided on the ground wire that connects the negative-side wire to the vehicle body. This can reduce the possibility of short-circuiting between the positive-side and negative-side of the battery even when the positive-side wire comes into contact with the vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a power supply device and a vehicle according to a first embodiment;

FIG. 2 is a flowchart showing an example of a process that is performed by an interruption control unit;

FIG. 3 is a schematic configuration diagram showing a power supply device and a vehicle according to a second embodiment; and

FIG. 4 is a schematic configuration diagram showing a power supply device and a vehicle according to s third embodiment.

### DETAILED DESCRIPTION OF EMBODIMENTS

Hereinafter, embodiments of the present disclosure will be described in detail with reference to the drawings.

### First Embodiment

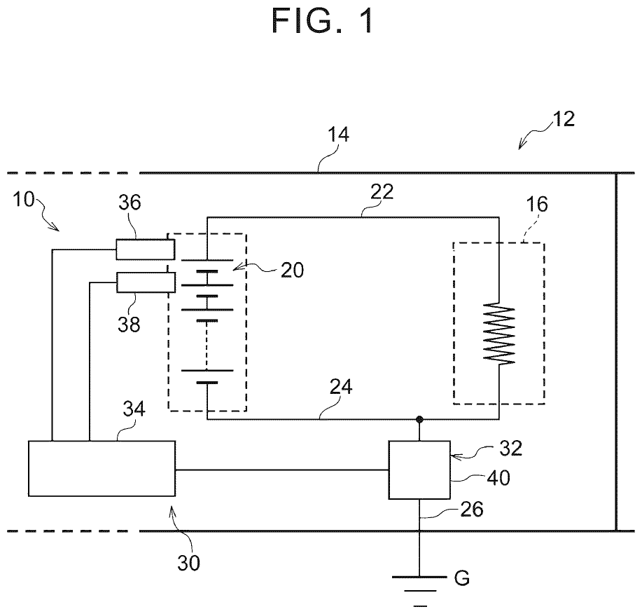

In a first embodiment, a vehicle 12 is applied as a moving object, and a power supply device 10 mounted on the vehicle 12 is described as an example of a power supply device for a moving object. FIG. 1 schematically shows the configuration of the power supply device 10 according to the first embodiment and the vehicle 12 on which the power supply device 10 is mounted.

The vehicle 12 may be a hybrid electric vehicle (HEV) equipped with an engine and an electric motor (neither of them is shown) as driving sources for traction. The vehicle 12 may alternatively be a plug-in hybrid electric vehicle (PHEV). The vehicle 12 may be a battery electric vehicle (BEV) or a fuel cell electric vehicle (FCEV) in which an electric motor is used as a driving source for traction.

As shown in FIG. 1, the vehicle 12 has a vehicle body 14 grounded to the earth G (ground). An electric load 16 is mounted on the vehicle 12. The electric load 16 includes, for example, an electric motor that is driven by electric power (high-voltage power) supplied from the power supply device 10, and a control device that controls operation of the electric motor (not shown). The electric load 16 may further include various auxiliary devices and their control devices, as well as travel control devices, which operate on low-voltage direct current power (e.g., 12 V) in the vehicle 12.

The power supply device 10 includes a battery (storage battery or mobility battery) 20 serving as an energy storage unit, and a control unit (not shown) that controls output of electric power from the battery 20. In the power supply device 10, direct current power from the battery 20 is output under control of the control unit.

A primary battery or a secondary battery having a known configuration may be used as the battery 20, and the power supply device 10 and the vehicle 12 may employ known configurations as their basic configurations. When a secondary battery is used as the battery 20, the power supply device 10 includes a charge control function to charge the battery 20 with electric power supplied from a charging unit (not shown).

In the power supply device 10, the battery 20 and the electric load 16 are connected via a positive-side wire 22 and a negative-side wire 24. In the power supply device 10, a first end of the positive-side wire 22 is connected to the positive terminal of the battery 20, and a second end is connected to the positive side of the electric load 16. A first end of the negative-side wire 24 is connected to the negative terminal of the battery 20, and a second end is connected to the negative side of the electric load 16. Accordingly, the power supply device 10 can supply the electric load 16 with direct current power at a desired voltage output from the battery 20.

The power supply device 10 is provided with a ground wire 26. A first end of the ground wire 26 is connected to the negative-side wire 24, and a second end is connected to the vehicle body 14. In the vehicle 12, the power supply device 10 and the electric load 16 are thus grounded to the vehicle body 14 at a single point (body ground).

The power supply device 10 is provided with a cutoff device 30 that constitutes a cutoff unit. The cutoff device 30 includes an interrupter 32 and an interruption control unit 34. The cutoff device 30 is provided with a voltage sensor 36 and a current sensor 38 that are used to determine the operating state of the battery 20. The voltage sensor 36 detects the voltage of the battery 20 (i.e., the ground potential of the positive terminal), and the current sensor 38 detects the current output from the battery 20 (i.e., the output current).

The interrupter 32 is provided on the ground wire 26. The interrupter 32 employs a cutoff mechanism that electrically disconnects the vehicle body 14 from the negative-side wire 24 by disconnecting the ground wire 26.

In the interrupter 32 of the first embodiment, a Pyro-Fuse 40 is used as the cutoff mechanism. The Pyro-Fuse 40 includes a busbar, an igniter, and a piston housed within a case (none of them are shown). When the igniter is activated, the piston breaks the busbar, thereby electrically disconnecting the primary side from the secondary side of the busbar.

The Pyro-Fuse 40 is mounted on the ground wire 26 such that the primary side of the busbar is on the negative-side wire 24 side, and the secondary side is on the vehicle body 14 side. Accordingly, in the cutoff device 30, when the igniter of the Pyro-Fuse 40 is activated, the connection (electrical connection) between the negative-side wire 24 and the vehicle body 14 is interrupted (i.e., the insulation resistance increases).

In the cutoff device 30, the voltage sensor 36, the current sensor 38, and the Pyro-Fuse 40 (its igniter) are each connected to the interruption control unit 34.

The interruption control unit 34 includes a microcomputer (not shown) in which a central processing unit (CPU), a read-only memory (ROM), a random access memory (RAM), a nonvolatile storage, input/output interfaces (I/Fs), and the like are connected via a bus. In the interruption control unit 34, the CPU reads programs such as a cutoff control program stored in the ROM and the storage, and executes them while loading them into the RAM. Based on the voltage (voltage value) detected by the voltage sensor 36 and the current (current value) detected by the current sensor 38, the interruption control unit 34 determines whether the positive-side wire 22 is in contact with the vehicle body 14. When such contact (i.e., leakage current) is detected, the interruption control unit 34 activates the Pyro-Fuse 40 to disconnect the ground wire 26.

Next, functions of the first embodiment will be described.

In the power supply device 10, the battery 20 and the electric load 16 are connected via the positive-side wire 22 and the negative-side wire 24, and direct current power from the battery 20 is supplied to the electric load 16. In addition, in the power supply device 10, the negative-side wire 24 is connected at a single point to the vehicle body 14 via the ground wire 26 (single-point grounding).

Generally, in a vehicle, a low-voltage circuit is provided to supply direct current power from a low-voltage auxiliary battery (e.g., 12 V) to auxiliary loads. The negative side of the auxiliary battery is grounded to the vehicle body, and the negative side of each auxiliary load is also grounded to the vehicle body, thereby forming the low-voltage circuit.

On the other hand, in a vehicle equipped with an electric motor as a driving source for traction, a high-voltage circuit is provided in addition to the low-voltage circuit to drive the electric motor. In the high-voltage circuit, a battery that outputs a high voltage (in the case of a direct current voltage in a vehicle, for example, 200 V to 300 V) is connected to the electric motor. In this configuration, the high-voltage circuit is maintained in a state in which both the positive side and the negative side are electrically isolated from the vehicle body. However, when the high-voltage circuit is electrically isolated from the vehicle body, noise can become an issue.

In the power supply device 10, the negative-side wire 24 is grounded to the vehicle body 14 at a single point via the ground wire 26. As a result, the generation of noise caused by the power supply device 10 is reduced in the vehicle 12.

On the other hand, in the power supply device 10, for example, a leakage current may occur if the positive-side wire 22 comes into contact with the vehicle body 14. In the power supply device 10, if the positive-side wire 22 comes into contact with the vehicle body 14, the positive-side wire 22 may be connected to the negative-side wire 24 via the vehicle body 14 and the ground wire 26, causing the battery 20 to be short-circuited.

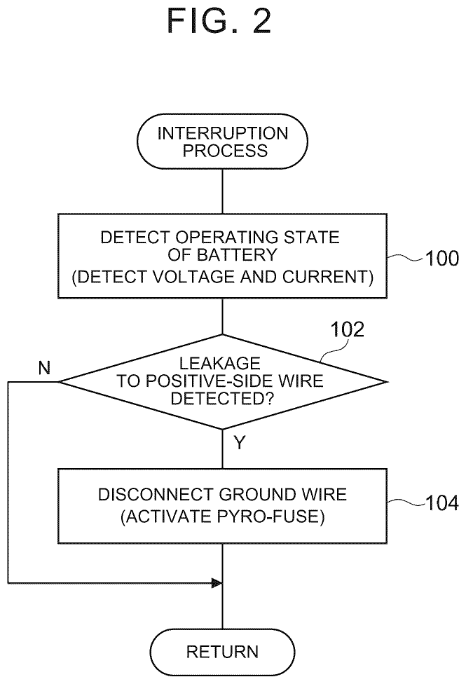

The power supply device 10 is provided with the cutoff device 30. FIG. 2 is a flowchart schematically illustrating an interruption process executed by the interruption control unit 34 as an operation of the cutoff device 30. The process shown in FIG. 2 is repeatedly executed by the interruption control unit 34 while the power supply device 10 is in an operating state in which the battery 20 outputs power.

As shown in FIG. 2, the interruption control unit 34 first detects the operating state of the battery 20 in step 100. In detecting the operating state of the battery 20, the voltage sensor 36 detects the voltage (ground potential) of the battery 20, and the current sensor 38 detects the current (output current) of the battery 20. The cutoff device 30 may have any configuration as long as at it performs at least one of voltage detection and current detection.

Next, in step 102, the interruption control unit 34 determines whether leakage to the ground wire has been detected due to the positive-side wire 22 coming into contact with the vehicle body 14, based on the output voltage (ground potential) and the output current. When the positive-side wire 22 is not in contact with the vehicle body 14, both the voltage and the output current (output power) fall within predetermined specified ranges. In this case, the interruption control unit 34 makes a negative determination in step 102.

In contrast, when the positive-side wire 22 comes into contact with the vehicle body 14 and a leakage current occurs in the positive-side wire 22, an abnormal condition such as a sudden drop in voltage (ground potential) occurs, and the voltage falls out of the specified range. In addition, when a leakage current occurs in the positive-side wire 22, an abnormal condition such as a sudden increase in output current occurs, and the output current falls out of the specified range.

When the interruption control unit 34 detects that at least one of the voltage and the output current has fallen out of the specified range, it determines that a leakage current has occurred in the positive-side wire 22, and makes an affirmative determination in step 102. The process then proceeds to step 104.

In step 104, the interruption control unit 34 activates the Pyro-Fuse 40. When the Pyro-Fuse 40 is activated in the power supply device 10, the negative-side wire 24 and the vehicle body 14 are brought into an electrically insulated state (i.e., insulation resistance becomes high). As a result, in the power supply device 10, the positive-side wire 22 is electrically isolated from the negative-side wire 24, thereby reducing the possibility of short-circuiting of the battery 20.

Accordingly, in the power supply device 10, the battery 20 is less likely to be short-circuited due to a leakage current resulting from the positive-side wire 22 coming into contact with the vehicle body 14, thereby suppressing a failure resulting from short-circuiting of the battery 20.

### Second Embodiment

Next, a second embodiment will be described. The basic configuration of the second embodiment is the same as that of the first embodiment. In the second embodiment, components having the same functions as those in the first embodiment are denoted by the same signs as those of the first embodiment, and detailed description thereof will be omitted.

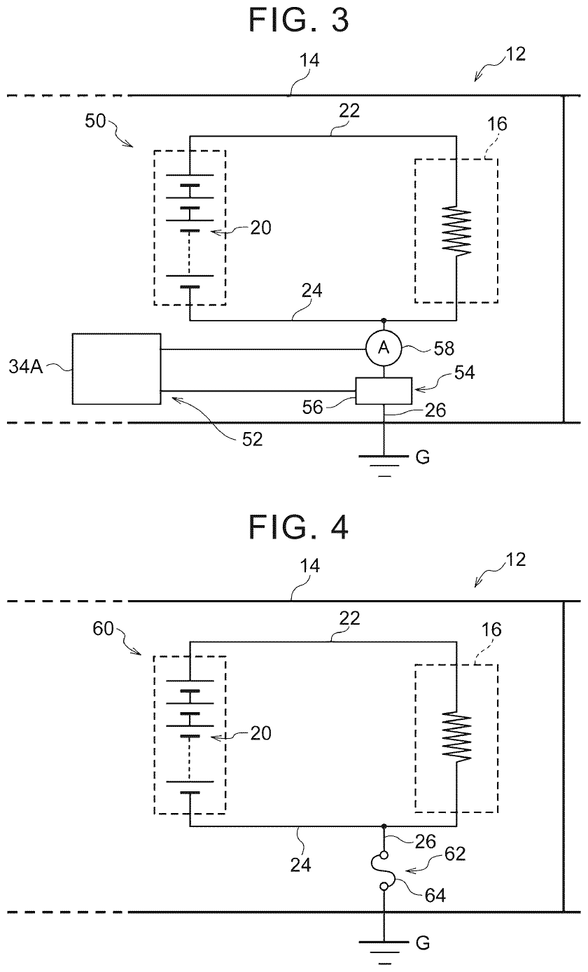

FIG. 3 schematically shows the configuration of a power supply device 50 serving as a power supply device for a moving object according to the second embodiment, and the vehicle 12 serving as a moving object on which the power supply device 50 is mounted.

As shown in FIG. 3, the power supply device 50 according to the second embodiment is provided with a cutoff device 52. The cutoff device 52 is provided in the power supply device 50 in place of the cutoff device 30 of the first embodiment.

In the cutoff device 52, an interrupter 54 is provided on the ground wire 26. A cutoff switch 56 is used in the interrupter 54. A system main relay (SMR), that is, a high-voltage relay in which an electromagnet is used to open and close contacts, is used as the cutoff switch 56. The cutoff switch 56 has its primary side connected to the ground wire 26 on the negative-side wire 24 side, and its secondary side connected to the ground wire 26 on the vehicle body 14 side.

The cutoff device 52 is also provided with an ammeter (current sensor) 58 on the ground wire 26 as a detection unit. The ammeter 58 detects a current (current value) flowing through the ground wire 26.

In the cutoff device 52, the cutoff switch 56 and the ammeter 58 are connected to an interruption control unit 34A. The interruption control unit 34A basically has the same functions as the interruption control unit 34, but differs in that it uses the ammeter 58 instead of the voltage sensor 36 and the current sensor 38, and activates the cutoff switch 56 instead of the Pyro-Fuse 40.

When the current value detected by the ammeter 58 increases and falls out of a predetermined specified range, the interruption control unit 34 determines that a leakage current has occurred in the positive-side wire 22 and activates the cut-off switch 56.

Accordingly, like the power supply device 10, the power supply device 50 reduces the possibility of electrical connection (short-circuiting) between the positive-side wire 22 and the negative-side wire 24 even if leakage occurs to the positive-side wire 22. As a result, in the power supply device 50, the battery 20 is less likely to be short-circuited due to a leakage current resulting from the positive-side wire 22 coming into contact with the vehicle body 14, thereby suppressing a failure resulting from short-circuiting of the battery 20.

### Third Embodiment

Next, a third embodiment will be described. The basic configuration of the third embodiment is the same as that of the first and second embodiments. In the third embodiment, components having the same functions as those in the first or second embodiment are denoted by the same signs as those of the first or second embodiment, and detailed description thereof will be omitted.

FIG. 4 schematically shows the configuration of a power supply device 60 serving as a power supply device for a moving object according to the third embodiment, and the vehicle 12 serving as a moving object on which the power supply device 60 is mounted.

As shown in FIG. 4, the power supply device 60 is provided with an interrupter 62 on the ground wire 26, and a fuse (thermal fuse) 64 is used in the interrupter 62. The fuse 64 generates heat in accordance with the value of the current flowing through the ground wire 26, and melts to disconnect the ground wire 26 when the current exceeds a specified value (falls out of a specified range).

Accordingly, like the power supply devices 10, 50, the power supply device 60 reduces the possibility of short-circuiting between the positive-side wire 22 and the negative-side wire 24 even if leakage occurs to the positive-side wire 22, thereby suppressing a failure resulting from short-circuiting of the battery 20.

The vehicle 12 is used as an example in the first through third embodiments. However, any configuration may be applied as the moving object as long as the power supply device and the electric load are arranged on an electrically conductive body of the moving body.

What is claimed is:

1. A power supply device for a moving object, the power supply device comprising:
a storage battery mounted on the moving object and connected to an electric load via a positive-side wire and a negative-side wire, the storage battery being configured to supply electric power to the electric load;
a ground wire that connects the negative-side wire at a single point to a body of the moving object in which the storage battery and the electric load are housed; and
a cutoff unit configured to interrupt a connection between the negative-side wire and the body via the ground wire when determination is made that the positive-side wire has come into contact with the body.

2. The power supply device according to claim 1, wherein:
the cutoff unit includes an interrupter configured to interrupt the connection via the ground wire when activated, and an interruption control unit configured to control activation of the interrupter; and
the interruption control unit is configured to activate the interrupter when at least one of an output voltage and an output current of the storage battery falls out of a predetermined specified range.

3. The power supply device according to claim 1, wherein:
the cutoff unit includes an interrupter configured to interrupt the connection via the ground wire when activated, and an interruption control unit configured to control activation of the interrupter; and
the interruption control unit is configured to activate the interrupter when a current value of the ground wire exceeds a predefined current value.
